(19) United States
(12) Patent Application Publication
(10) Pub. No.: US 2007/0157969 A1
(43) Pub. Date: Jul. 12, 2007

(54) DOSING METHOD AND APPARATUS FOR LOW-PRESSURE SYSTEMS

(76) Inventor: Karl Gross, Fremont, CA (US)

Correspondence Address: STEVEN VOSEN, 1563 SOLANO AVENUE #206, BERKELEY, CA, 94707, US

(21) Appl. No.: 11/621,713

(22) Filed: Jan. 10, 2007

Related U.S. Application Data
(60) Provisional application No. 60/758,612, filed on Jan. 12, 2006.
(60) Provisional application No. 60/744,933, filed on Apr. 16, 2006.

(51) Int. Cl. F17D 1/00

(52) U.S. Cl. 137/2

(57) ABSTRACT

A method and apparatus are presented for controlling the flow of gas from a source to a low-pressure device which is particularly useful for sampling high pressure gases. Examples are presented for the high-pressure dosing of an RGA. In one embodiment, the method isolates volumes of gases at high pressure, limits their pressure, and provides the gas at low pressure. In one embodiment the apparatus includes valves, flow restriction devices, and check valves, and can be used, for example, to either provide accurate and repeatable quantities discrete doses of gas from high pressure to low pressure or provide continuous dosing from high to low pressure. The apparatus and method are relatively insensitive to source pressure, and thus provide reproducible results over a range of source pressures.

### CROSS-REFERENCE TO RELATED APPLICATIONS

This application claims the benefit of U.S. Provisional Application No. 60/758,612, filed Jan. 12, 2006, and U.S. Provisional Application No. 60/744,933, filed Apr. 16, 2006. The entire contents of the above-listed provisional applications are hereby incorporated by reference herein and made part of this specification.

### BACKGROUND OF THE INVENTION

1. Field of the Invention

The present invention relates to a device and method for the controlled dosing and flow of a gas or mixture of gases to an instrument capable of analyzing the gas.

2. Discussion of the Background

There are many situations where gases are supplied to gas analysis or processing devices that operate at low pressure. Thus, for example, devices for testing or evaluating gases, such as a residual gas analyzer (RGA) or a gas chromatograph/mass spectrometer (GC/MS), and low pressure chemical reactors, such as those used in semiconductor wafer manufacturing, typically require a large or steady source of gas. Typically, these devices operate at low pressures, such as high vacuum (HV), from approximately 100 mPa to approximately 100 nPa, or ultra high vacuum (UHV), from approximately 100 nPa to approximately 100 pPa.

Gases are generally provided to analysis devices by flowing the gas through an orifice into the analysis chamber. For high-quality analysis, the flow of gas through the orifice is preferably constant. Constant flow is usually achieved by supplying the gas upstream to the orifice through a capillary from source that is essentially at constant pressure and/or by differential pumping. Thus, for example, the gas may be supplied from a gas source having a large volume, and can thus supply the gas at an essentially constant pressure. For differential pumping, the gas supply includes the differential pumping of the supply gas by rough pumping an intermediate volume located between two orifices, or between an orifice and a capillary tube. One problem with this approach is that, unless gas is continuously supplied to this sample volume, the pressure continuously drops towards the base pressure of the roughing pump. As a result, the conditions of the sample, and thus the quantification of analysis, may be difficult or impossible to obtain. In addition, when it is desired to test a small sample of amount of gas, rather than a continual flowing gas, it is difficult to maintain a fixed upstream pressure, and/or it is not possible to use the same differential pump to pump both the test gas and to back-up the high-vacuum (turbo) pump. In addition, if the source gas is at different pressures and the orifice is fixed, it may not be possible to test gas samples under the same conditions because the flow rates through the orifice will be different.

Thus there is a need in the art to provide a device and method for an improved supply for low pressure systems. Such a method and device should, in various embodiments, be capable of supplying small quantities of gases at know or measurable conditions, prevent overloading UHV systems, and permit the easy comparison of analysis data from different sources.

### BRIEF SUMMARY OF THE INVENTION

In certain embodiments, an apparatus is provided that can deliver multiple doses of gas each having the same number of moles of gas to a process or analytical instrument.

In certain embodiments, an apparatus is provided that can accept gas over a wide range of pressures and deliver multiple doses of gas each having the same number of moles of gas to a process or analytical instrument.

In certain embodiments, an apparatus is provided having RGA system that can accept gas at pressures greater than one atmosphere.

In certain embodiments, a dosing device is provided that can deliver gas from a source to a low-pressure device, which can be a gas analyzer or a process. In one embodiment, the dosing device has one or more passageways connecting an inlet to accept gas from the source, an outlet, a pressure relief device to limit the pressure of gas within the one or more passageways to be less than a first pressure, and at least one flow restriction device between the inlet and the outlet. In another embodiment, the dosing device has one or more passageways connecting an inlet to accept gas from the source, an outlet, one or more valves operable to form a first volume to accept gas from the source and a second volume to accept gas from the first volume, at least one flow restriction device between the second volume and the outlet. In one embodiment the first volume is smaller than the second volume. In another embodiment, the first volume is larger than or equal to the second volume. The gas analyzer or process accepts at least a portion of the gas from the outlet.

In certain embodiments, an apparatus is provided to deliver gas from a source to a low-pressure device. The apparatus includes a dosing device and a gas analyzer or a process. The dosing device has one or more passageways connecting an inlet to accept gas from the source, an outlet, a pressure relief device to limit the pressure of gas within the one or more passageways to be less than a first pressure, and at least one flow restriction device between the inlet and the outlet. The gas analyzer or process accepts at least a portion of the gas from the outlet.

In certain embodiments, an apparatus is provided to deliver gas from a source to a low-pressure device, where, in one embodiment, the source is a process, and in another embodiment, the source is an analytical instrument.

In certain embodiments, an apparatus is provided to deliver gas from a source to a low-pressure device, where, in one embodiment, the low-pressure device is a residual gas analyzer, in another embodiment, the low-pressure device includes a mass spectrometer, and in yet another embodiment, the low-pressure device includes a gas chromatograph.

In certain embodiments, an apparatus is provided to deliver gas from a source to a low-pressure device, where the apparatus includes a dosing device to provide a continuous stream of gas. In other certain embodiments, the dosing device provides discrete doses of gas. In yet other certain embodiments, the dosing device provides a plurality of doses having the same number of moles.

In certain embodiments, an apparatus is provided to deliver gas from a source to a low-pressure device, including a dosing device having pressure relief device to limit the pressure of gas to be less than a pressure that is in the range of from approximately 0.001 MPa to approximately 50 MPa.

In certain embodiments, an apparatus is provided to deliver gas from a source to a low-pressure device, including a dosing device having an inlet and an outlet, that accepts gas at the inlet at a pressure in the range of from approximately 10⁻⁷ Torr (10⁻⁵ Pa) to approximately 500 bar (50 MPa). In certain other embodiments, the pressure at the outlet is in the range of from approximately 10⁻⁴ Torr (10⁻² Pa) to approximately 10⁻¹⁰ Torr (10⁻⁸ Pa).

In certain embodiments, an apparatus is provided to deliver gas from a source to a gas analyzer. The apparatus includes a dosing device and a gas analyzer. The dosing device has one or more passageways connecting an inlet to accept gas from the source, an outlet, one or more valves operable to form a first volume to accept gas from the source and a second volume to accept gas from the first volume, at least one flow restriction device between the second volume and the outlet. The gas analyzer accepts at least a portion of the gas from the outlet. In one embodiment the first volume is smaller than the second volume. In another embodiment, the first volume is larger than or equal to the second volume.

In certain embodiments, a method provides doses of gas having a fixed number of moles. The method includes: accepting gas from a source into a volume, where the pressure of the source is greater than a first pressure, and where said first pressure is greater than one atmosphere; isolating the volume of accepted gas from the source; venting gas from the isolated volume to reduce the volume pressure to the first pressure; and, after venting gas, providing the remaining gas from the volume to a low-pressure system.

These features together with the various ancillary provisions and features which will become apparent to those skilled in the art from the following detailed description, are attained by the apparatus described herein, preferred embodiments thereof being shown with reference to the accompanying drawings, by way of example only, wherein:

### BRIEF DESCRIPTION OF THE SEVERAL VIEWS OF THE DRAWING

FIG. 1 is a schematic of a first embodiment system including a dosing device;

FIG. 2 is a schematic of a second embodiment system including a dosing device;

FIG. 3 is a schematic of an alternative embodiment system of FIG. 2;

FIG. 4 is a first embodiment of a dosing device;

FIG. 5 is a second embodiment of a dosing device;

FIG. 6 is a third embodiment of a dosing device;

FIG. 7 is a fourth embodiment of a dosing device;

FIG. 8 is a fifth embodiment of a dosing device;

FIGS. 9A-9F are schematic illustrations of the system of FIG. 8 having different dosing device valve configurations, where FIG. 9A is a first valve configuration, FIG. 9B a second valve configuration, FIG. 9C is a third valve configuration, FIG. 9D is a fourth valve configuration, FIG. 9E is a fifth valve configuration, and FIG. 9F is a sixth valve configuration; and

FIGS. 10A, 10B, and 10C are RGA spectra obtained during a Temperature Programmed Desorption, where FIG. 10A is the spectra at a first time, FIG. 10B is the spectra at a second time, and FIG. 10C is the spectra at third time.

Reference symbols are used in the Figures to indicate certain components, aspects or features shown therein, with reference symbols common to more than one Figure indicating like components, aspects or features shown therein.

### DETAILED DESCRIPTION OF THE INVENTION

Although certain preferred embodiments and examples are disclosed below, it will be understood by those skilled in the art that the inventive subject matter extends beyond the specifically disclosed embodiments to other alternative embodiments and/or uses of the invention and obvious modifications and equivalents thereof. Thus it is intended that the scope of the inventions herein disclosed should not be limited by the particular disclosed embodiments described below. Thus, for example, in any method or process disclosed herein, the acts or operations making up the method/process may be performed in any suitable sequence, and are not necessarily limited to any particular disclosed sequence. For purposes of contrasting various embodiments with the prior art, certain aspects and advantages of these embodiments are described where appropriate herein. Of course, it is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

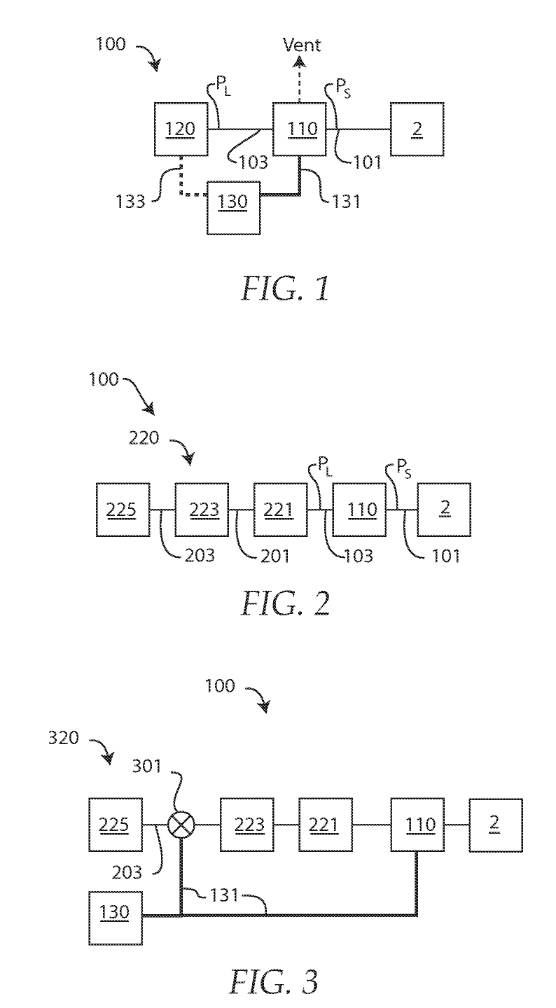

FIG. 1 is a schematic of a first embodiment of a system 100 that includes a dosing device 110, a low-pressure device 120, and an operating system 130. In system 100, a source of gas 2 is provided to an inlet 101 of dosing device 110 which, in turn, provides the source gas through an outlet 103 of the dosing device to a low-pressure device 120. Inlet 101 and outlet 103 are, in general, flow passageways and may either be plumbed directly into source 2 and low-pressure device 120, or may include connectors at one or both of inlet 101 or outlet 103. In general, source 2 provides a gas to inlet 101 at a pressure Pₛ, and low-pressure device 120 operates a pressure P_{L} that is less than Pₛ. In one embodiment the pressure P_{L} is sub-atmospheric, including but not limited to HV or UHV pressures, and the pressure Pₛ is a pressure greater than P_{L} as is, for example sub-atmospheric, atmospheric, or greater than atmospheric pressure.

In one embodiment, inlet 101 accepts gas into dosing device 110 at pressures Pₛ of from approximately 10⁻⁷ Torr (10⁻⁵ Pa) to approximately 500 bar (50 MPa). Examples of values of Pₛ which are not meant to limit the scope of the present invention also include a pressure range with a minimum pressure of: approximately 10⁻⁷ Torr (10⁻⁵ Pa); approximately 10⁻⁶ Torr (10⁻⁴ Pa); approximately 10⁻⁵ Torr (10⁻³ Pa); approximately 10⁻⁴ Torr (10⁻² Pa); approximately 10⁻³ Torr (10⁻¹ Pa); approximately 10⁻² Torr (1 Pa); approximately 10⁻¹ Torr (10 Pa); approximately 1 Torr (10² Pa); approximately 10 Torr (10³ Pa); approximately 0.1 bar (10⁴ Pa); approximately 1 bar (0.1 MPa); approximately 10 bar (1 MPa); approximately 100 bar (10 MPa); approximately 200 bar (20 MPa); and approximately 500 bar (50 MPa).

In another embodiment, outlet 103 provides gas to low-pressure device 120 at pressures P_{L} from approximately 10⁻⁴ Torr (10⁻² Pa) to approximately 10⁻¹⁰ Torr (10⁻⁸ Pa). Examples of values of P_{L} which are not meant to limit the scope of the present invention include, but are not limited to a maximum pressure of: approximately 10⁻¹⁰ Torr (10⁻⁸ Pa); approximately 10⁻⁹ Torr (10⁻⁷ Pa); approximately 10⁻⁸ Torr (10⁻⁶ Pa); approximately 10⁻⁷ Torr (10⁻⁵ Pa); approximately 10⁻⁶ Torr (10⁻⁴ Pa); approximately 10⁻⁵ Torr (10⁻³ Pa); approximately 10⁻⁴ Torr (10⁻² Pa); approximately 10⁻³ Torr (10⁻¹ Pa); and approximately 10⁻² Torr (1 Pa).

Source 2 may include, but not limited to, one or more tube or other passageways for flowing a gas, and one or more valves, pressure relief devices, pressure regulators, flow restricting devices, and includes, but is not limited to, a material processing device or primary measuring device, pressure cylinders, and/or pumps. In certain embodiments, source 2 is the outflow from a gas analysis device, a gas sorption analysis device, a high pressure natural gas reformation process, petrochemical gas production process, chemical synthesis process involving a gas phase, chemical reaction process involving a gas phase, a vapor deposition materials process, from hydrogen fuel cell testing equipment, hydrogen fuel cell operations, hydrogen fuel cell hydrogen fueling supply tests, hydrogen sorption materials, carbon dioxide sorption materials, nitrogen sorption materials, carbon monoxide sorption materials, oxygen sorption materials, water vapor sorption materials, water vapor sorption testing, steam, or high-purity gasses for materials processing. One example of a primary measuring device, which is not meant to limit the scope of the present invention, source 2 is the PCTPro-2000, manufactured by Hy-Energy, LLC (Newark, Calif.). Alternatively, a source 2 may provide gas both to dosing device 110 and to a primary measuring device.

In general, dosing device 110 contains flow devices connected together that may be operated to deliver gas from inlet 101 to outlet 103. When dosing device 110 is connected through inlet 101 and outlet 102 to source 2 and a device 120, dosing device 110 can control the pressure and/or flow of gas between source 2 and device 120. The gas may be delivered, in various embodiments, as a continuous flow of gas, or as one or more discrete samples of gas controlled, for example, with valves within dosing device 110. The flow devices of dosing device 110 may include, but not limited to, one or more tubes or other passageways for flowing a gas, and one or more valves, pressure regulators, pressure relief devices, flow restricting devices, or pumps.

In several embodiments, dosing device 110 maintains a pressure at outlet 103 by diverting a part of the gas from inlet 101 to an optional vent, as shown in FIG. 1. In one embodiment, the vent is at atmospheric pressure. In another embodiment, dosing device 110 includes a vacuum pump or line, and the vent is to a sub-atmospheric pressure. In one embodiment, dosing device 110 includes one or more of a check valve or pump to control the venting of gas. Venting permits the gas at outlet 103 from exceeding some predetermined pressure. Limiting the pressure has many advantages for system 100. Thus, for example, some low-pressure devices include sensitive analytical instruments, such as mass spectrometers, that do not provide measurements at pressures that are too high, or that are not easily quantifiable as the pressure varies.

In several other embodiments, dosing device 110 includes two or more volumes between inlet 101 and outlet 103, where the volumes are separated by flow devices including, but not limited to, on-off valves, check valves, and/or flow restrictions. In one embodiment, dosing device 110 provides discrete doses to outlet 103. Alternatively, one embodiment permits the dosing device 110 to be operated to permit a continuous flow through the two or more volumes. In yet another embodiment, dosing device 110 includes two or more volumes and a vent, and outlet 103 is adapted to deliver gas at a known volume and pressure. In a further embodiment, when the temperature of dosing device 110 is approximately constant, the dosing device delivers an approximately constant number of moles of gas per dose.

One- or two-way communications are provided between dosing device 110, low-pressure device 120, and operating system 130. Thus, for example, dosing device 110 generally includes actuators that are controlled, via lines 131, from operating system 130, which may be a manually operated system or a computer controlled system. In one embodiment, dosing device 110 includes one or more valves that are electrically controlled, and lines 131 include electrical control lines. In another embodiment, dosing device 110 includes one or more valves that are pneumatically controlled, and lines 131 include pressure and/or vacuum lines. In addition to providing communication between operating system 130 and dosing device 110, lines 131 may also provide communication from the dosing device back to the operating system 130. Thus for example, an electrical indication of an actuator may be provided, or a signal provided by a pressure transducer or other measuring device.

In an alternative embodiment, operating system 130 includes lines 133 for communication with low-pressure device 120. Thus, for example, low-pressure device 120 may provide signal over line 131 to operating system 130 that a previous dose of gas has been analyzed or processed, and the proper signals are then sent over lines 131 to deliver the next dose.

Low-pressure device 120 is, in general, a low-pressure device or process, and includes, but not limited to, a gas analysis device, a vapor deposition materials process, a hydrogen fuel cell or hydrogen fuel cell testing equipment, hydrogen fuel cell operations, hydrogen fuel cell hydrogen fueling supply tests, carbon dioxide sorption materials, nitrogen sorption materials, carbon monoxide sorption materials, oxygen sorption materials, water vapor sorption materials, water vapor sorption testing, steam, and high-purity gasses for materials processing. Gas analysis device include, but are not limited to, residual gas analyzers, gas chromatograph/mass spectrometers, gravimetric analyzers (including, but not limited to, those manufactured by Hiden Analytical Ltd (Warrington, UK), RUBOTHERM—Prazisionsmesstechnik (Bochum, Germany), VTI Corporation (Hialeah, Fla.)); volumetric analyzers (including, but not limited to, those manufactured by Hiden Analytical Ltd, Couter, Advanced Materials Corporation (Pittsburgh, Pa.), Micromeritics Instrument Corporation (Norcross, Ga.), Quantachrome Instruments (Boynton Beach, Fla.); and Temperature Programmed Desorption (TPD), Flow TPD or Flow TPR, manufactured by Quantachrome Instruments. Alternatively, low-pressure device 120 is a process or application that requires exact or approximately equal molar doses of gas.

It is to be understood that the different components of system 100 may be different from that shown in FIG. 1 and still be within the scope of the present invention. Thus, for example, in one embodiment, low-pressure device 120 may include a computerized operating system 130 that communicates directly with dosing device 110. In another embodiment, dosing device 110 is integrated into a design of a low-pressure device 120.

FIG. 2 is a schematic of a second embodiment of system 100 that includes a low-pressure device 220. System 100 is generally similar to the embodiment of FIG. 1, and low-pressure device 220 is generally similar to low-pressure device 120, except as further detailed below. Where possible, similar elements are identified with identical reference numerals in the depiction of the embodiments of FIGS. 1 and 2.

Dosing device 110 of FIG. 2 accepts gas from source 2 into inlet 101 at a first pressure Pₛ, and delivers some or all of the gas at outlet 103 at a second, lower pressure P_{L}, and then provides the gas to low-pressure device 220. In one embodiment, low-pressure device 220 is a gas analysis system that includes an RGA 221, a turbo pump 223, and a roughing pump 225. A gas line 201 connects RGA 221 and turbo pump 223, and a gas line 203 connects turbo pump 223 and roughing pump 225. RGA 221 is a mass spectrometer, which is typically used for process control and contamination monitoring in the semiconductor industry. In one embodiment RGA 221 is a Stanford Research Systems RGA, manufactured by Stanford Research Systems, Inc. (Sunnyvale, Calif.) turbo pump 223 is a hybrid turbomolecular drag pump manufactured by Pfeiffer Vacuum GmbH (Asslar, Germany), and roughing pump 225 is a diaphragm pump manufactured by Pfeiffer Vacuum GmbH (Asslar, Germany).

In one embodiment, system 100 accepts gas at a pressure Pₛ of from approximately 10⁻⁸ Torr (10⁻⁶ Pa) to approximately 200 bar (20 MPa), and provides gas at a pressure P_{L} of from approximately 10⁻⁴ Torr (10⁻² Pa) to approximately 10⁻¹⁰ Torr (10⁻⁸ Pa). In one embodiment, the pressure P_{L} is within the operating range of low-pressure device. Thus, for example, P_{L} is within the operating range of the RGA.

FIG. 3 is a schematic of a third embodiment of system 100 that includes a low-pressure device 320. System 100 is generally similar to the embodiment of FIGS. 1 and 2, and low-pressure device 320 is generally similar to low-pressure devices 120 and 220, except as further detailed below. Where possible, similar elements are identified with identical reference numerals in the depiction of the embodiments of FIGS. 1, 2, and 3.

Low-pressure device 320 includes a valve 301 in gas line 203 between the turbo pump 223 and roughing pump 225. Valve 301, which may be controlled via line 131 from operating system 130, can be closed to prevent the flow of gas from roughing pump 225 to the turbo pump 223 and RGA 221 during venting of system 300 to atmosphere or higher pressure.

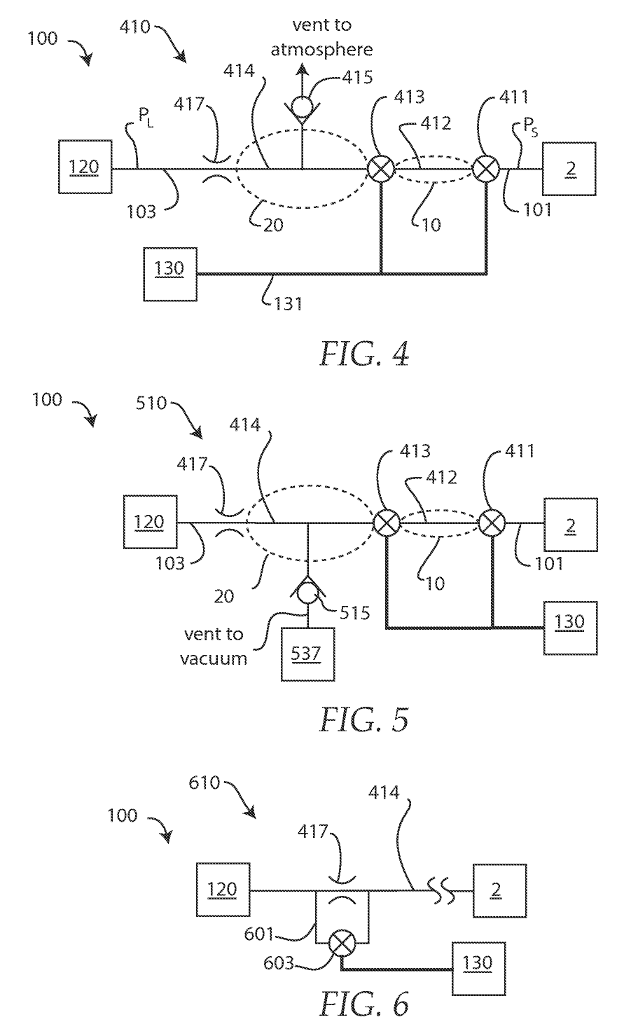

FIG. 4 is a schematic of an embodiment of system 100 that includes a dosing device 410. System 100 is generally similar to the embodiment of FIGS. 1-3, and dosing device 410 is generally similar dosing device 110, except as further detailed below. Where possible, similar elements are identified with identical reference numerals in the depiction of the embodiments of FIGS. 1-4.

In general, dosing device 410 includes portions between inlet 101 and outlet 103 that form a first volume, referred to herein without limitation, as the dose volume 10 and having a volume V10, and a second volume, referred to herein and without limitation, as the sample volume 20 and having a volume V20.FIG. 4 illustrates one embodiment to provide a dose volume 10 and sample volume 20.

Dosing device 410 includes a first valve 411, a second valve 413, a passageway 412 connecting the first and second valves, a flow pressure relief device, or check valve 415, a flow restriction, referred to herein and without limitation as an orifice 417, passageways 414 connecting the second valve, check valve, and orifice and extending to low-pressure device 220 or 320.

Check valve 415 releases gas from passageways 414 if the gas pressure in those passageways exceeds a predetermined amount. Dosing device 410 may provide gas, for example, to low-pressure device 120 which may be, for example and without limitation, one of low-pressure devices 220 or 320.

Dose volume 10 is the volume of dosing device 410 within the internal volumes of passageway 412 and valves 411 and 413. Sample volume 20 is the volume of dosing device 410 within the volume of the internal volumes of passageways 414 from second valve 413, check valve 415, and orifice 417. As described subsequently, valves 411 and 413 may be operated to allow the dosing or flow of gas from source 2 towards low-pressure device 120.

In one embodiment, the volume ratio V20:V10 is greater than one. In another embodiment, the ratio V20:V10 is greater than one. In various other embodiments, the ratio V20:V10 is within the range of from 100:1 to 1:100, and includes, but is not limited to a ratio of: 100:1; 50:1; 10:1; 5:1; 3:1; 2:1; 1:1; 1:2; 1:5; 1:10; 1:50; or 1:100.

In certain embodiments, the volumes V10 and V20 are in the range of microliters to 10's of milliliters. In certain embodiments, V10 and V20 are in the range of from 0.1 ml and 1.0 ml.

In certain embodiments, orifice 417 has a diameter of less than 1000 μm, of less than 100 μm, of less than 50 μm, of less than 10 μm, of less than 5 μm, of less than 2 μm, of less than 1 μm, or less than 0.1 μm, or less than 0.01 μm.

In certain other embodiments, check valve 415 limits the pressure within sample volume 20 to a pressure of: 50 MPa or less; 10 MPa or less; 4 MPa or less; 1 MPa or less; 0.1 MPa or less; 0.01 MPa or less; or 0.001 MPa or less.

Pumps 223 and 225, orifice 417, check valve 415, and valves 411 and 413 are all sized and rated to accept gas from a source at high pressure and provide small amounts of gas to the RGA at low pressure. Thus, for example, Pₛ may be greater than 0.1 MPa, greater than 0.2 MPa, greater than 0.5 MPa, greater than 1.0 MPa, greater than 2.0 MPa, greater than 5.0 MPa, greater than 10.0 MPa, or may be 20 MPa or greater. Also, for example, Pₛ may be a low pressure or a UHV pressure, including but not limited to a pressure less than 10⁵ Pa while the RGA may operate under UHV pressures on the order of less than 10⁻⁵ Pa. In one embodiment, valves 411 and 413 are high pressure valves having a small dead space, such as a Valco pneumatic On/Off valves (VICI Valco Instruments, Houston, Tex.), check valve 415 is a spring or other type of adjustable check valve, such as an adjustable Check Valve SS-4CA-VCR-50 manufactured by Swagelok Company (Solon, Ohio).

In one embodiment, the diameter of orifice 417 is 3 μm, Pₛ ranges from approximately 10⁻⁴ Pa to approximately 20 MPa, check valve 415 is set to open at a pressure of 0.3 MPa, roughing pump 225 can pump down to a pressure of 10 Pa, turbo pump 223 can pump down to a pressure of 10⁻⁸ Pa, and valves 411 and 413 can operating at pressure of up to 70 MPa, V10 is 0.25 ml and V20 is 0.7 ml.

The dosing of low-pressure device 120 may be accomplished by first supplying gas at elevated pressures, that is, greater than a pressure in low-pressure device 120, into dose volume 10. Thus, for example, first valve 411 is first opened with second valve 413 closed. Next, first valve 411 is closed and second valve 413 is opened, releasing gas from dose volume 10 into sample volume 20. Gas in sample volume 20 then flows through orifice 417 towards low-pressure device 120. Check valve 415 is set to open for a pressure difference ΔP, and releases gas from sample volume 20 if the pressure exceeds that amount. The excess pressure of sampling gas, that is that gas with a pressure greater than the ΔP of check valve 415, is released to the vent or atmosphere, while gas flow from sample volume 20, which is maintained at a constant pressure, flows through orifice 417 into low-pressure device 120. In an alternative embodiment, valves 411 and 413 are open, and gas flows continuously from source 2 into low-pressure device 120, with the pressure limited to the pressure determined by the check valve.

FIG. 5 is a schematic of an embodiment of system 100 that includes a second embodiment of a dosing device 510. System 100 is generally similar to the embodiment of FIGS. 1-4, and dosing device 510 is generally similar dosing devices 110 and 410, except as further detailed below. Where possible, similar elements are identified with identical reference numerals in the depiction of the embodiments of FIGS. 1-5.

Dosing device 510 is configured for sample volume 20 to vent to a sub-atmospheric pressure. In the embodiment of FIG. 5, dosing device 510 includes a second roughing pump 527 and a pressure relief device, or check valve 515. In this embodiment, the pressure upstream of check valve 515 is maintained at a pressure less than one atmosphere by roughing pump 527. Thus in this embodiment, the pressure in sample volume 20 is held nearly constant at a pressure much lower than the pressure in the embodiment of FIG. 4. In an alternative embodiment of the embodiment of FIG. 5, not shown, low-pressure device 120 is low-pressure device 220, and roughing pump 537 and roughing pump 225 are the same pump.

FIG. 6 is a schematic of an embodiment of system 100 that includes a third embodiment of a dosing device 610. System 100 is generally similar to the embodiment of FIGS. 1-5 and dosing device 610 is generally similar dosing devices 110, 410, and 510, except as further detailed below. Where possible, similar elements are identified with identical reference numerals in the depiction of the embodiments of FIGS. 1-6.

FIG. 6 shows detail of dosing device 610 near orifice 417, as may be incorporated into any of the embodiments described herein utilizing an orifice. Dosing device 610 includes a bypass line 601 around orifice 417, where the bypass lines include a valve 603. Valve 603 can be operated, for example by operating system 130, to control the diversion of gas from sample volume 20 towards low-pressure device 220 or 320. Valve 603, which is preferable an on-off valve, enables the purging, that is the pumping down, of the sample volume 20 to obtain a background spectrum, or to purge out gas from a previous dose.

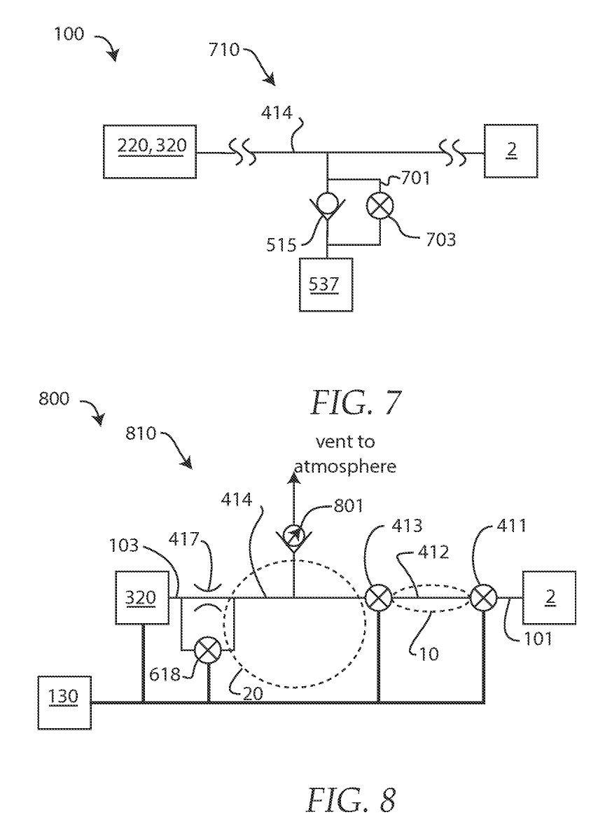

FIG. 7 is a schematic of an embodiment of system 100 that includes a fourth embodiment of a dosing device 710. System 100 is generally similar to the embodiment of FIGS. 1-6, and dosing device 710 is generally similar dosing devices 110, 410, 510 and 610, except as further detailed below. Where possible, similar elements are identified with identical reference numerals in the depiction of the embodiments of FIGS. 1-7.

FIG. 7 shows detail of dosing device 710 near check valve 515, as may be incorporated into any of the embodiments described herein utilizing a check valve. Dosing device 710 includes a bypass line 701 around check valve 415, where the bypass line includes a valve 703. Valve 703 can be operated, for example by operating system 130, to control the diversion of gas about check valve 415. Valve 415 allows sample volume 20 to be pumped down to rough vacuum pressures using roughing pump 537.

FIG. 8 is a schematic of an embodiment of system 800 that includes a fifth embodiment of a dosing device 810 connected to a low-pressure device 320. System 800 is generally similar to system 100, and dosing device 810 is generally similar dosing devices 110, 410, 510, 610, and 710, except as further detailed below. Where possible, similar elements are identified with identical reference numerals in the depiction of the embodiments of FIGS. 1-8.

Dosing device 810 includes a check valve 801 to permit a user to select the maximum pressure of sample volume 20. In one embodiment, check valve 801 is a Swagelok CA series check valve, and may be set to a pressure of from approximately 0.01 MPa to approximately 4 MPa.

In one embodiment, the volume of sample volume 20 is three times larger than the volume of dose volume 10. This increase in volumes as the gas flows through dosing device 810 results in a pressure drop when the dosing device is operated in a mode to provide doses.

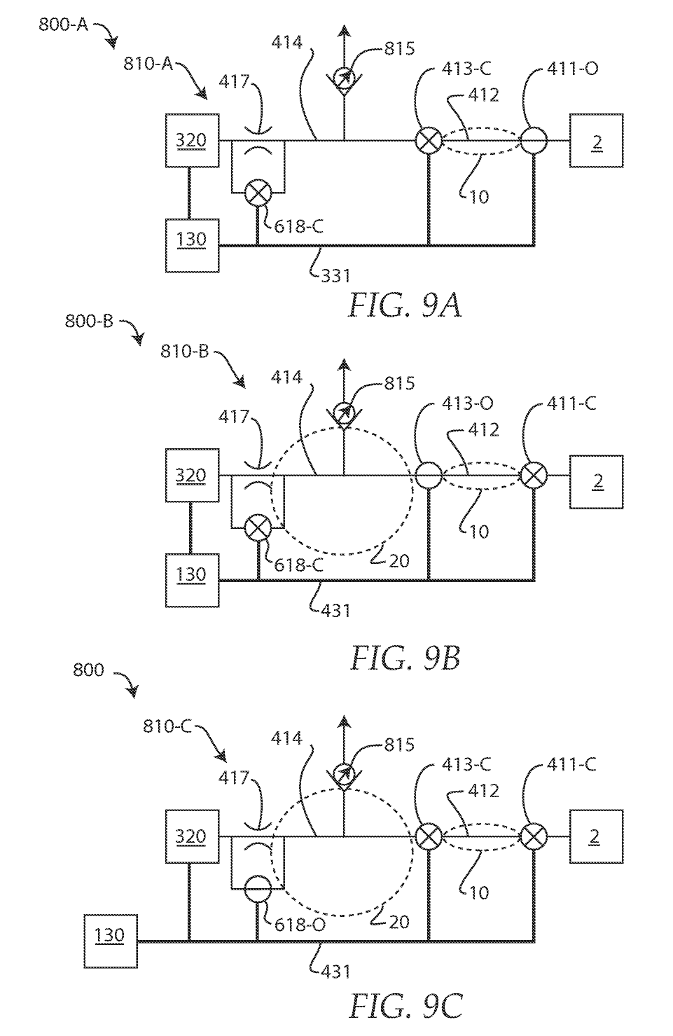

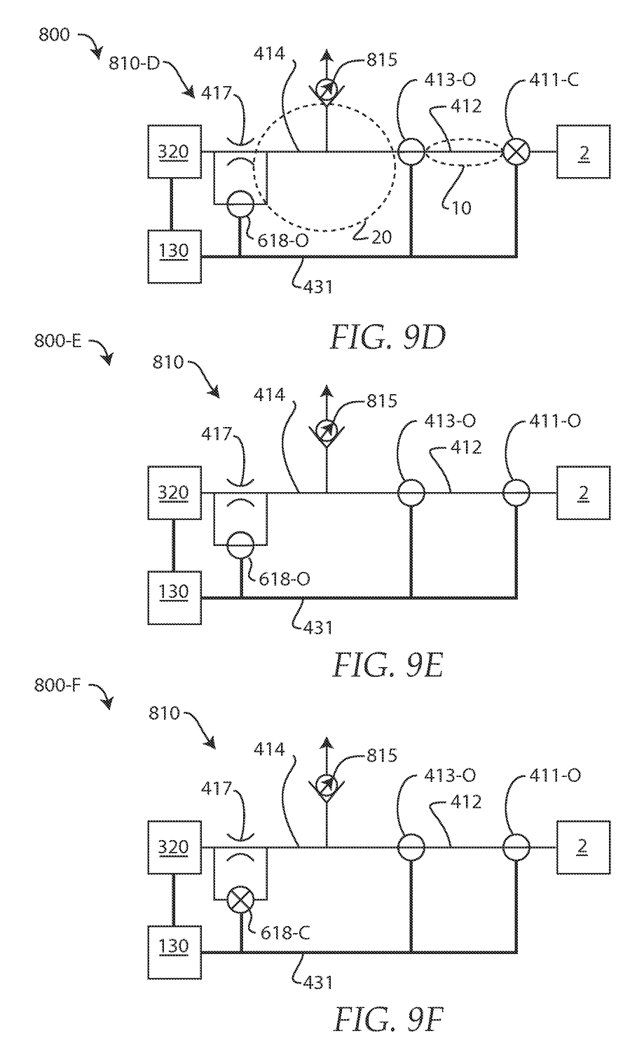

FIGS. 9A-9F are schematic illustration system 800, having dosing device 810 configured as dosing device 810-A, 810-B, 810-C, 810-D, 810-E, and 810-F, respectively. Each of FIGS. 9A-9F show different settings for valves 411, 413, and 618. Each of valve 411, 413, and 618 connects passageways on either side of the valve and has two positions: an “open” position to fluidly connect the passageways; and a “closed” position to fluidly disconnect the passageways. FIG. 9A is a first valve configuration, FIG. 9B is a second valve configuration, FIG. 9C is a third valve configuration, FIG. 9D is a fourth valve configuration, FIG. 9E is a fifth valve configuration, and FIG. 9F is a sixth valve configuration. where FIG. 9A is a first valve configuration, FIG. 9B is a second valve configuration, FIG. 9C is a third valve configuration, FIG. 9D is a fourth valve configuration, FIG. 9E is a fifth valve configuration, and FIG. 9F is a sixth valve configuration. An open valve is indicated by a straight line through the valve and a suffix “-O” appended to the reference numeral, such as 411-O, 413-O, or 618-O. A closed valve is indicated with an “X” through the valve and a suffix “-C” appended to the reference numeral, such as 411-C, 413-C, or 618-C.

In the first valve configuration of FIG. 9A, system 800 is shown in configuration 800-A, with valve 411 open, valve 413 closed, and valve 618 closed. System 800-A permits fluid communication between source 2 and dose volume 10 and between sample volume 20 and low-pressure device 320 through orifice 417.

In the second valve configuration of FIG. 9B, system 800 is shown in configuration 800-B, with valve 411 closed, valve 413 open, and valve 618 closed. This configuration of valve settings permits fluid communication between dose volume 10, sample volume 20, and low-pressure device 320 through orifice 417.

In the third valve configuration of FIG. 9C, system 800 is shown in configuration 800-C, with valve 411 closed, valve 413 closed, and valve 618 open. This configuration of valve settings isolates dose volume 10 and permits fluid communication between sample volume 20 and low-pressure device 320 through orifice 417.

In the fourth valve configuration of FIG. 9D, system 800 is shown in configuration 800-D, with valve 411 closed, valve 413 open, and valve 618 open. This configuration of valve settings permits fluid communication between dose volume 10, sample volume 20 and low-pressure device 320 through or bypassing orifice 417.

In the fifth valve configuration of FIG. 9E, system 800 is shown in configuration 800-E, with valve 411 open, valve 413 open, and valve 618 open. This configuration of valve settings permits fluid communication between source 2, dose volume 10, sample volume 20 and low-pressure device 320 through or bypassing orifice 417.

In the sixth valve configuration of FIG. 9F, system 800 is shown in configuration 800-F, with valve 411 open, valve 413 open, and valve 618 closed. This configuration of valve settings permits fluid communication between source 2, dose volume 10, sample volume 20 and low-pressure device 320 through orifice 417.

There are several gas delivery and maintenance operations that can be performed methods for using system 800 to provide doses of gas from source 2 to low-pressure device 320. Several methods are now discussed as examples of the use of system 800 that may be used, for example and without limitation, to measure the residual gases from a source 2 which may be, for example, in the main gas or evolved alone by desorption from a sample or coming from an application such as a fuel cell, chemical reaction, bake out of a system, or processing material. The following methods involve sequences of valve opening and closing that are meant to respect the operational limits of low-pressure devices.

Line Clearing

In one embodiment, dosing device 810 is used to clear the gas lines by pumping the dose volume 10 and sample volume 20 down to a background pressure level. This mode of operation is typically preferred before providing a sample gas to low-pressure device 320. Line clearing is performed with valve 411 closed and valves 413 and 618 open (configuration 800-D), and using pumps in low-pressure device 320 to obtain a desired pressure.

Low Pressure Gas Sampling

In another embodiment, dosing device 810 is used for low-pressure gas sampling. If the user of system 800 is certain that the pressure in source 2 will not be sufficiently high to damage any component of low-pressure device 320, then dosing device 810 can be used to provide the sample from the source directly into the low-pressure device. For this mode of operation, with valves 413 and 618 closed, valve 411 is opened (configuration 800-A), then valve 413 is opened (configuration 800-F), and then valve 618 is opened (configuration 800-E, bypassing orifice 417. The pressure of source 2 is the same as that provided to low-pressure device 320.

High-Pressure Gas Sampling

In one embodiment, dosing device 810 is operated to limit the pressure of gas delivered to low pressure device 320. Thus, for example, if the pressure of source 2 is too high for the safe operation of low-pressure device 320, or if it is otherwise useful to limit the pressure of the gas being provided to the low-pressure device, then the maximum pressure within sample volume 20 is set by check valve 815.

As one example as a method to sample at high pressures, check valve 815 is set to open at 3×10⁵ Pa, orifice 417 has a diameter of 3.0 μm, and the volume ratio V20:V10 is 3:1. System 800 is first configured with each of valves 411, 413, and 618 closed, as shown in FIG. 8. Next, valve 411 is opened (configuration 800-A) for a few seconds to admit a high pressure sample into dose volume 10, and then is closed again to isolate the sample. If the volume of dose volume 10 is significantly less than the volume of source 2, then this operation permits the source gas to be sampled without significantly changing the pressure of the gas within the source. Maintaining a small variation in source pressure is particularly useful when making quantitative volumetric measurements of gases desorbed from solid material samples.

Then, valve 413 is opened (configuration 800-B), permitting gas to expand from dose volume 10 into sample volume 20, and to also flow through orifice 417 into low-pressure device 320. If the pressure in sample volume 20 exceeds the set pressure of check valve 815, then some gas will vent, The remaining gas will flow from sample volume 20, through orifice 417, and into RGA 221. In one embodiment, RGA 221 scans the sample within a few seconds after system 800 is placed in configuration 800-B.

Gas provided to RGA 221 at pressures greater than that at which check valve 815 opens, and at the same temperature, will contain the same molar quantity of gas. This feature can be utilized for the comparative analysis of the composition of the gas from sample to sample.

With a volume ratio V20:V10 greater than one, gas provided from dose volume 10 to sample volume 20 expands and the pressure falls. In another embodiment, volume V20 is smaller than V10, (the ratio V20:V10 is less than one) and check valve 815 is set to open at a pressure that will always vent within the operating pressure of source 2. Thus, for example, some process, such as reformation processes to produce hydrogen, or petrochemical gas process, the pressure may vary significantly or fluctuate. This device could then be used to always dose the same moles of gas sample to an RGA regardless of what the source pressure is doing. Allowing a good comparative compositional analysis during a fluctuating continuous process.

Sample Vacuum

In yet another embodiment, dosing device 810 is used to obtain a vacuum at inlet 101. One method for providing a vacuum to the sample is, starting with valves 411, 413, and 618 closed, open valve 411 (configuration 800-A), and then open valve 413 (configuration 800-F), and then open valve 618 (configuration 800-E). This allows for direct analysis using RGA 221 of a gas from the source 2 without any pressure drop or restriction.

Continuous High-Pressure Gas Sampling

In one embodiment, dosing device 810 is used to provide a continuous sample of gas to low-pressure device 320. One method for continuous gas sampling is with valves 411 and 413 open and valve 618 closed (configuration 800-F). Gas from source 2 then flows to orifice 417 and into low-pressure device 320. Any excess pressure in sample volume 20 is limited by check valve 815.

When connected to a source 2 than heats a material that desorbs gas when heated, configuration 800-F permits the measurement of a Temperature Programmed Desorption. Changes of the concentrations of different gasses as they are being evolved from source 2 may be measured in RGA 221 as a function of time and/or temperature of the source.

### EXAMPLE

System 800 was used to obtain RGA mass spectra of the devolution of gas during a Temperature Programmed Desorption. A source 2 included a sample of 0.185 gram LiH, 0.537 gram Mg, 0.592 gram Al, 1.033 gram LiNH2, and 0.12 gram TiF3 enclosed in a volume of 13.2 ml. The source 2 was heated from 96° C. to 300° C. over 108 minutes. Check valve 815 was set to limit the pressure in sample volume 20 to 3.71×10⁵ Pa. System 800 was used to measure gas desorption of a relatively large sample, while maintaining a relatively constant pressure sample volume pressure.

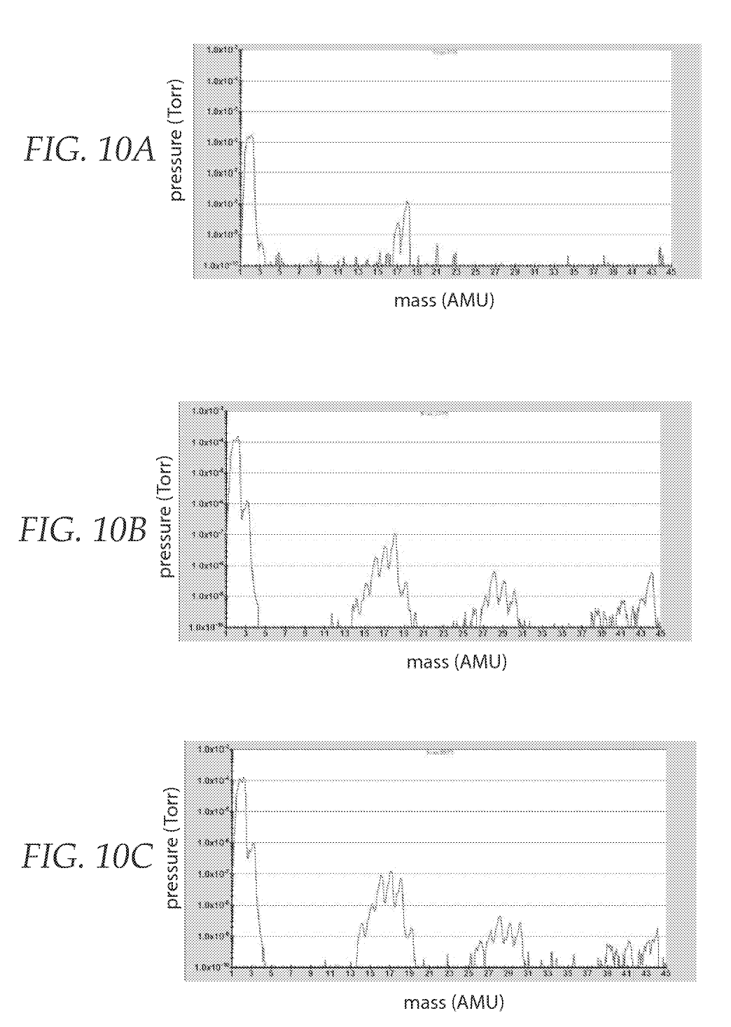

The results from the Temperature Programmed Desorption are shown in FIGS. 10A, 10B, and 10C, where FIG. 10A is the spectra at a first time, FIG. 10B is the spectra at a second time, and FIG. 10C is the spectra at third time. Specifically, FIG. 10A shows the spectra at time=0, a pressure of 1.3×10⁵ Pa and a temperature of 96° C. at source 2. FIG. 10B shows the spectra at time=44 minutes, a pressure of 3.71×10⁵ Pa, and a temperature of 250° C. FIG. 10C shows the spectra at a time=108 minutes, a pressure of 3.60×10⁵ Pa, and a temperature of 300° C.

FIGS. 10A-10C show the amount of hydrogen and ammonia desorbing from the sample, and the increase in ammonia above the presence of water by the appearance of a peak at 14 AMU (Atomic Mass Units), the change in peak intensities at 15, 16, and 17 AMU, and the decreasing intensity of the peak at 18 AMU. The simultaneous measurement of pressure of the gas surrounding the sample and up to the aperture, shows and increase in pressure with temperature as the sample desorbs hydrogen and other gasses. At 44 minutes (FIG. 10B) the pressure reached 3.71×10⁵ Pa, which is the pre-set relief pressure of valve 815. As gas continues to be desorbed from the sample the pressure in sample 2 maintained at a constant value of about 3.71×10⁵ Pa by relieving through pressure relief valve 815. This allows the freshly desorbed gas to reach the aperture and be measured by the RGA, and also permits the pressure in sample 2 to be regulated by dosing device 810.

Reference throughout this specification to “certain embodiments,” “one embodiment” or “an embodiment” means that a particular feature, structure or characteristic described in connection with the embodiment is included in at least one embodiment of the present invention. Thus, appearances of the phrases “in a certain embodiment,” “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

I claim:

1. An apparatus to deliver gas from a source to a low-pressure device, said apparatus comprising:
a dosing device having one or more passageways connecting
an inlet to accept gas from the source,
an outlet,
a pressure relief device to limit the pressure of gas within said one or more passageways to be less than a first pressure, and
at least one flow restriction device between said inlet and said outlet; and
a gas analyzer or process to accept at least a portion of the gas from said outlet.

2. The apparatus of claim 1, where said first pressure is in the range of from approximately 0.001 MPa to approximately 50 MPa.

3. The apparatus of claim 1, where said inlet accepts gas at a pressure in the range of from approximately 10⁻⁷ Torr (10⁻⁵ Pa) to approximately 500 bar (50 MPa).

4. The apparatus of claim 3, where the pressure at the outlet is in the range of from approximately 10⁻⁴ Torr (10⁻² Pa) to approximately 10⁻¹⁰ Torr (10⁻⁸ Pa).

5. The apparatus of claim 1, where said dosing device includes a first volume to accept gas from the inlet and a second volume to provide gas to the outlet, and where said pressure relief device limits the pressure in said second volume.

6. The apparatus of claim 5, where said first pressure in said second volume within the range of approximately 0.001 MPa to approximately 50 MPa.

7. The apparatus of claim 5, where said flow restriction device is between said second volume and said outlet.

8. The apparatus of claim 7, where said flow restriction device includes an orifice having a diameter of from approximately 0.1 μm to approximately 10 μm.

9. The apparatus of claim 1, where said gas analyzer or process includes a residual gas analyzer.

10. The apparatus of claim 1, where said gas analyzer or process includes a mass spectrometer.

11. The apparatus of claim 1, where said gas analyzer or process includes a gas chromatograph.

12. The apparatus of claim 1, where said dosing device provides continuous samples of gas to said gas analyzer or process.

13. The apparatus of claim 1, further comprising one or more valves operable to provide discrete samples of gas to said gas analyzer or process.

14. The apparatus of claim 13, where, for source gas pressures greater than the pressure relief pressure, each discrete sample has approximately the same number of moles of gas.

15. The apparatus of claim 13, further comprising one or more valves operable to provide continuous samples of gas to said gas analyzer or process.

16. The apparatus of claim 1, where said source is a process.

17. The apparatus of claim 1, where said source is an analytical instrument.

18. An apparatus to deliver gas from a source to a low-pressure device, said apparatus comprising:
a dosing device having one or more passageways connecting
an inlet to accept gas from the source,
an outlet,
one or more valves operable to form a first volume to accept gas from the source and a second volume to accept gas from said first volume,
at least one flow restriction device between said second volume and said outlet; and
a gas analyzer or process to accept at least a portion of the gas from said outlet.

19. The apparatus of claim 18, where said first volume is smaller than said second volume.

20. The apparatus of claim 18, where said first volume is larger than or equal to said second volume.

21. The apparatus of claim 18, where said inlet accepts gas at a pressure in the range of from approximately 10⁻⁷ Torr (10⁻⁵ Pa) to approximately 500 bar (50 MPa).

22. The apparatus of claim 21, where the pressure at the outlet is in the range of from approximately 10⁻⁴ Torr (10⁻² Pa) to approximately 10⁻¹⁰ Torr (10⁻⁸ Pa).

23. The apparatus of claim 18, where said dosing device includes a pressure relief device to limit the pressure of gas within said second volume to a maximum pressure.

24. The apparatus of claim 23, where said pressure relief device limits the pressure within said second volume to be less than a pressure in the range of from approximately 0.001 MPa to approximately 50 MPa.

25. The apparatus of claim 18, where said flow restriction device includes an orifice having a diameter from approximately 0.1 μm to approximately 10 μm.

26. The apparatus of claim 18, where said gas analyzer or process includes a residual gas analyzer.

27. The apparatus of claim 18, where said gas analyzer or process includes a mass spectrometer.

28. The apparatus of claim 18, where said gas analyzer or process includes a gas chromatograph.

29. The apparatus of claim 18, where said dosing device provides continuous samples of gas to said gas analyzer or process.

30. The apparatus of claim 18 where said dosing device provides discrete samples of gas to said gas analyzer or process.

31. The apparatus of claim 18, where, for source gas pressures greater than the pressure relief pressure, each discrete sample has approximately the same number of moles of gas.

32. The apparatus of claim 18, where said source is a process.

33. The apparatus of claim 18, where said source is an analytical instrument.

34. A method to provide doses of gas having a fixed number of moles, said method comprising:
accepting gas from a source into a volume, where the pressure of the source is greater than a first pressure, where said first pressure is greater than one atmosphere;
isolating said volume of accepted gas from said source;
venting gas from the isolated volume to reduce the volume pressure to the first pressure; followed by
providing the remaining gas from the volume to a low-pressure device.

35. The method of claim 34, where said first pressure is greater than one atmosphere.

36. The method of claim 34, where said first pressure is less than or equal to one atmosphere.

37. The method of claim 34, where said source gas is provided by a process.

38. The method of claim 34, where said source gas is provided by an analytical instrument.

39. The method of claim 34, where said low-pressure device includes an analytical instrument.

40. The method of claim 34, where said low-pressure device includes a process.
